(19) United States
(12) Patent Application Publication
(10) Pub. No.: US 2025/0136009 A1
(43) Pub. Date: May 1, 2025

(54) TWO-DIMENSIONAL (2-D) ARRAYS OF TRANSITION METAL NITRIDES FOR LI-METAL ANODES

(71) Applicant: Drexel University, Philadelphia, PA (US)

(72) Inventors: Yury Gogotsi, Warminster, PA (US); Xu Xiao, Philadelphia, PA (US); Wei Yao, Philadelphia, PA (US); Jun Tang, Philadelphia, PA (US)

(21) Appl. No.: 18/947,781

(22) Filed: Nov. 14, 2024

Related U.S. Application Data
(63) Continuation of application No. 17/613,716, filed on Nov. 23, 2021, now abandoned.
(60) Provisional application No. 62/852,514, filed on May 24, 2019.

(51) Int. Cl. B60R 9/06; B60R 11/00; H01M 4/38; H01M 4/58; H01M 10/0525

(52) U.S. Cl. CPC B60R 9/06; H01M 4/382; H01M 4/58; H01M 10/0525; B60R 2011/004; B60R 2011/0075; B60R 2011/0082

(57) ABSTRACT

The present disclosure is directed to freestanding films for a lithium-metal-anode comprising a 2D arrays of nanocrystals of a transition metal nitride, carbide, or mixture and optionally a MXene as a conductive binder, and methods of making and using the same.

### CROSS REFERENCE TO RELATED APPLICATIONS

The present application is a continuation of U.S. patent application Ser. No. 17/613,716, “Two-Dimensional (2-D) Arrays Of Transition Metal Nitrides For Li-metal Anodes,” filed Nov. 23, 2021; which is the National Stage Application of International Patent Application No. PCT/US2020/034289, “Two-Dimensional (2-D) Arrays Of Transition Metal Nitrides For Li-metal Anodes,” filed May 22, 2020; which claims priority to and the benefit of U.S. Patent Application No. 62/852,514, “Two Dimensional (2-D) Arrays Of Transition Metal Nitrides For Li-Metal-Anodes,” filed May 24, 2019. All foregoing applications are incorporated herein by reference in their entireties for any and all purposes.

### TECHNICAL FIELD

The present disclosure relates to lithium metal electrodes, lithium ion batteries, and components and methods of using the same.

### BACKGROUND

Li-metal-anodes are an attractive choice for Li-batteries due to its high theoretical capacity (3680 mAh/g) and low redox potential (−3.04 V). Despite many advantages, Li-metal-anode are plagued with several practical issues, such as dendrite growth during Li plating/stripping process. This can result in short-circuit of the cell along with safety issues. Accordingly, there is a long-felt need for improved such materials.

### SUMMARY

In meeting the long-felt needs in the art, the present disclosure is directed to two-dimensional (2D) arrays of transition metal nitrides and carbides nanocrystals as the conducting framework for Li deposition, in turn realizing highly stable Li-metal-anodes. The 2D arrays of metal nitrides and carbides include, e.g., 2D arrays of CrN, TiN, NbN, Cr₂C, et al. The disclosed technology makes available methods of fabricating stable Li-metal-anodes for, inter alia, practical high energy Li-batteries.

To tackle these issues, one can electrodeposit Li into a conducting. Transition metal carbides and nitrides nanocrystals are useful materials as the framework for Li deposition due to the high electron conductivity and lithiophilicity. The materials in PCT/US2019/067429 (incorporated herein by reference in its entirety) are considered suitable.

In the present disclosure are used two-dimensional (2D) arrays of transition metal nitrides and carbide nanocrystals as the conducting framework for Li deposition, in turn realizing highly stable Li-metal-anodes. The 2D arrays of metal nitrides and carbides include 2D arrays of CrN, TiN, NbN, Cr₂C, and the like.

In one aspect, the present disclosure provides a free-standing film, comprising: a 2D array of nanocrystals of a transition metal nitride, carbide, or a mixture thereof, the free-standing film optionally further comprising a MXene as a conductive binder.

Also provided are lithium-metal-anode, comprising the freestanding film of the present disclosure.

Further provided is a lithium ion battery, comprising the freestanding film of the present disclosure.

Also provided is an electronic device, comprising: a free-standing film of the present disclosure.

Additionally provided are methods, comprising communicating a current to a free-standing film according to the present disclosure.

Further provided are methods, comprising operating a lithium-metal anode according to the present disclosure.

Also provided are methods, comprising charging or discharging a lithium ion battery according to the present disclosure

Further provided are methods, comprising operating an electronic device according to the present disclosure.

Additionally provided are methods, comprising depositing a metal or a metal ion onto or within a film according to the present disclosure.

Also provided are methods, the methods comprising releasing a metal or a metal ion from a film according to the present disclosure.

Further provided are methods, comprising fabricating a free-standing film according to the present disclosure.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various aspects discussed in the present document. In the drawings:

FIG. 1 provides an example cross-sectional SEM image of NbN/Ti₃C₂ freestanding film.

FIG. 2 provides illustrative cycling performances of NbN/Ti₃C₂ electrode at 1 mA/cm² for 1 mAh/cm² for 500 cycles. Here, NbN-number means the weight percentage of NbN in freestanding electrode.

### DETAILED DESCRIPTION OF ILLUSTRATIVE EMBODIMENTS

The present invention may be understood more readily by reference to the following description taken in connection with the accompanying Figures and Examples, all of which form a part of this disclosure. It is to be understood that this invention is not limited to the specific products, methods, conditions or parameters described or shown herein, and that the terminology used herein is for the purpose of describing particular embodiments by way of example only and is not intended to be limiting of any claimed invention. Similarly, unless specifically otherwise stated, any description as to a possible mechanism or mode of action or reason for improvement is meant to be illustrative only, and the invention herein is not to be constrained by the correctness or incorrectness of any such suggested mechanism or mode of action or reason for improvement. Throughout this text, it is recognized that the descriptions refer to compositions and methods of making and using said compositions. That is, where the disclosure describes or claims a feature or embodiment associated with a composition or a method of making or using a composition, it is appreciated that such a description or claim is intended to extend these features or embodiment to embodiments in each of these contexts (i.e., compositions, methods of making, and methods of using). Again, embodiments directed to methods of making a composition also provide embodiments for the compositions themselves.

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value can be one non-limiting method of determining the extent of the word “about.” In other cases, the gradations used in a series of values can be used to determine the intended range available to the term “about” for each value. Where present, all ranges are inclusive and combinable. That is, references to values stated in ranges include every value within that range.

It is to be appreciated that certain features of the invention which are, for clarity, described herein in the context of separate embodiments, can also be provided in combination in a single embodiment. That is, unless obviously incompatible or specifically excluded, each individual embodiment is deemed to be combinable with any other embodiment(s) and such a combination is considered to be another embodiment. Conversely, various features of the invention that are, for brevity, described in the context of a single embodiment, can also be provided separately or in any sub-combination. Finally, while an embodiment can be described as part of a series of steps or part of a more general structure, each said step can also be considered an independent embodiment in itself, combinable with others. For example, in the present disclosure, the formation of the nitrides is described in the Examples as comprising three optional steps: (1) forming a salt matrix comprising a transition metal precursor crystalline salt to form a reaction precursor; (2) reacting this reaction precursor under otherwise inert (non-oxidative) environment, but comprising a hydrocarbon or an amine to form a product matrix comprising a transition metal nitride and the crystalline salt; and (3) dissolving the salt to provide the product two-dimensional nitride or carbide nanocrystals. In this case, steps (1), (2), and (3) each individually represent independent embodiments, as do steps (1) and (2), (2) and (3), and the combination of steps (1), (2), and (3). In the cases of multiple steps, each step can be conducted sequentially or at the same time.

The transitional terms “comprising,” “consisting essentially of,” and “consisting” are intended to connote their generally in accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element, step, or ingredient not specified in the claim; and (iii) “consisting essentially of” limits the scope of a claim to the specified materials or steps “and those that do not materially affect the basic and novel characteristic(s)” of the claimed invention. Embodiments described in terms of the phrase “comprising” (or its equivalents), also provide, as embodiments, those which are independently described in terms of “consisting of” and “consisting essentially of.” For those embodiments provided in terms of “consisting essentially of,” the basic and novel characteristic(s) is the facile operability of the methods (or the systems used in such methods or the compositions derived therefrom) to provide 2D (transition) transition metal carbides or nitrides.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.” Similarly, a designation such as C₁₋₃ includes C₁, C₂, C₃, C₁₋₂, C₂₋₃, C₁₋₃, as separate embodiments, as well as C₁₋₃.

Throughout this specification, words are to be afforded their normal meaning, as would be understood by those skilled in the relevant art. However, so as to avoid misunderstanding, the meanings of certain terms will be specifically defined or clarified.

The terms “2D (transition) metal carbide” or “2D (transition) metal nitride” refers to a crystalline metal carbide or nitride composition (including those comprising transition metal carbides or nitrides) having lattices which extend in two-dimensions (e.g., the x-y plane), such as associated sheets of (transition) metal atoms and carbon/nitrogen atoms, with nanometer(s) thickness or little or no extended crystalline structure (i.e., single or few unit cells directed) in the third dimension (e.g., the z-direction). While the methods can provide transition metal carbide or nitride compositions in powder form (which can be amorphous, semicrystalline, but generally crystalline morphology, or the crystallite size can be so small as to exhibit poor XRD definition or patterns), a feature of these 2D structures is their proclivity to form macroscopic flake structures, and in other embodiments, the 2D (transition) metal carbides or nitrides can be described in terms of having a (graphite-like) flake morphology. In some embodiments, and as shown herein, the sheets of (transition) metal atoms contain coatings of oxygenated or other heteroatom moieties. While these sheets can stack upon one another to form stacked assemblies, the bonding between adjacent sheets can be non-covalent. This contrasts the formation of macrostructured, crystalline materials. Transmission electron microscopy is useful in distinguishing such structures and for characterizing the 2D products as such.

“Optional” or “optionally” means that the subsequently described circumstance can or can not occur, so that the description includes instances where the circumstance occurs and instances where it does not.

MXenes can be or can be derived from any of the compositions described in any one of U.S. patents application Ser. No. 14/094,966, International Applications PCT/US2012/043273, PCT/US2013/072733, PCT/US2015/051588, PCT/US2016/020216, or PCT/US2016/028354, all of which are incorporated herein by reference in their entireties, along with PCT/US2019/067429. Specific such compositions are described elsewhere herein. In certain embodiments, the MXenes comprise substantially two-dimensional array of crystal cells, each crystal cell having an empirical formula of Mₙ₊₁Xₙ, or M′₂M″ₙXₙ₊₁, where M, M′, M″, and X are defined elsewhere herein. Those descriptions are incorporated here. In some independent embodiments, M is Ti or Ta. Additionally, or alternatively, X is C. The specification exemplifies the use of Ti₃C₂Tₓ as a precursor to, or as incorporated into, the nanocomposites.

Returning to the original description of the nanocomposites described herein, these nanocomposites comprise or are derived from one or more MXene compositions, in addition to the one or more oxide or oxide-type material. And again, typically, these MXene compositions exist within the grain boundaries of the nanocomposite matrix. The MXene compositions described herein are also sometimes described in terms of the phrase “MX-enes”or simply “MX-enes.” Most of the MXenes synthesized to date have metallic conductivity. For example, the two-dimensional titanium carbide, Ti₃C₂Tₓ, which is the mostly studied MXene, has conductivity in the range of 10³-10⁴ S cm⁻¹ for both individual flakes as well as in stacked films. MXenes have shown great promise for a variety of applications including energy storage, electromagnetic interference shielding, sensors, water purifications, and medicine.

In certain aspects, MXenes are two-dimensional transition metal carbides, nitrides, or carbonitrides comprising at least one layer having first and second surfaces, each layer described by a formula Mₙ₊₁Xₙ Tₓ and comprising:
a substantially two-dimensional array of crystal cells,
each crystal cell having an empirical formula of Mₙ₊₁Xₙ, such that each X is positioned within an octahedral array of M,
wherein M is at least one Group IIIB, IVB, VB, or VIB metal,
wherein each X is C, N, or a combination thereof;
n=1, 2, or 3; and wherein
Tₓ represents surface termination groups.

These so-called MXene compositions have been described in U.S. Pat. No. 9,193,595 and Application PCT/US2015/051588, filed Sep. 23, 2015, each of which is incorporated by reference herein in its entirety at least for its teaching of these compositions, their (electrical) properties, and their methods of making. That is, any such composition described in this Patent is considered as applicable for use in the present applications and methods and within the scope of the present invention. For the sake of completeness, M can be at least one of Sc, Y, Lu, Ti, Zr, Hf, V, Nb, Ta, Cr, Mo, or W. In certain embodiments in this class, M is at least one Group IVB, Group VB, or Group VIB metal, preferably Ti, Mo, Nb, V, or Ta. Certain of these compositions include those having one or more empirical formula wherein Mₙ₊₁Xₙ comprises Sc₂C, Ti₂C, V₂C, Cr₂C, Cr₂N, Zr₂C, Nb₂C, Hf₂C, Ti₃C₂, V₃C₂, Ta₃C₂, Ti₄C₃, V₄C₃, Ta₄C₃, SC₂N, Ti₂N, V₂N, Cr₂N, Cr₂N, Zr₂N, Nb₂N, Hf₂C, Ti₃N₂, V₃C₂, Ta₃C₂, Ti₄N₃, V₄C₃, Ta₄N₃ or a combination or mixture thereof. In particular embodiments, the Mₙ₊₁Xₙ structure comprises Ti₃C₂, Ti₂C, or Ta₄C₃. In some embodiments, M is Ti or Ta, and n is 1, 2, or 3, for example having an empirical formula Ti₃C₂ or Ti₂C. In some of these embodiments, at least one of said surfaces of each layer has surface terminations comprising hydroxide, oxide, sub-oxide, or a combination thereof. In certain preferred embodiments, the MXene composition is described by a formula Mₙ₊₁Xₙ Tₓ, where Mₙ₊₁Xₙ are Ti₂CTₓ, Mo₂TiC₂Tₓ, Ti₃C₂Tₓ, or a combination thereof, and Tₓ is as described herein. Those embodiments wherein M is Ti, and n is 1 or 2, preferably 2, are especially preferred.

Additionally, or alternatively, in other embodiments, the articles of manufacture and methods use compositions, wherein the two-dimensional transition metal carbide, nitrides, or carbonitride comprises a composition having at least one layer having first and second surfaces, each layer comprising:
a substantially two-dimensional array of crystal cells,
each crystal cell having an empirical formula of M′₂M″ₙXₙ₊₁, such that each X is positioned within an octahedral array of M′ and M″, and where M″ₙ are present as individual two-dimensional array of atoms intercalated (sandwiched) between a pair of two-dimensional arrays of M′ atoms,
wherein M′ and M″ are different Group IIIB, IVB, VB, or VIB metals (especially where M′ and M″ are Ti, V, Nb, Ta, Cr, Mo, or a combination thereof),
wherein each X is C, N, or a combination thereof, preferably C; and
n=1 or 2.

These compositions are described in greater detail in Application PCT/US2016/028354, filed Apr. 20, 2016, which is incorporated by reference herein in its entirety at least for its teaching of these compositions and their methods of making. In some embodiments, M′ is Mo, and M″ is Nb, Ta, Ti, or V, or a combination thereof. In other embodiments, n is 2, M′ is Mo, Ti, V, or a combination thereof, and M″ is Cr, Nb, Ta, Ti, or V, or a combination thereof. In still further embodiments, the empirical formula M′₂M″ₙXₙ₊₁ comprises Mo₂TiC₂, Mo₂VC₂, Mo₂TaC₂, Mo₂NbC₂, Mo₂Ti₂C₃, Cr₂TiC₂, Cr₂VC₂, Cr₂TaC₂, Cr₂NbC₂, Ti₂NbC₂, Ti₂TaC₂, V₂TaC₂, or V₂TiC₂, preferably Mo₂TiC₂, Mo₂VC₂, Mo₂TaC₂, or Mo₂NbC₂, or their nitride or carbonitride analogs. In still other embodiments, M′₂M″ₙXₙ₊₁ comprises Mo₂Ti₂C₃, Mo₂V₂C₃, Mo₂Nb₂C₃, Mo₂Ta₂C₃, Cr₂Ti₂C₃, Cr₂V₂C₃, Cr₂Nb₂C₃, Cr₂Ta₂C₃, Nb₂Ta₂C₃, Ti₂Nb₂C₃, Ti₂Ta₂C₃, V₂Ta₂C₃, V₂Nb₂C₃, or V₂Ti₂C₃, preferably MO₂Ti₂C₃, MO₂V₂C₃, MO₂Nb₂C₃, Mo₂Ta₂C₃, Ti₂Nb₂C₃, Ti₂Ta₂C₃, or V₂Ta₂C₃, or their nitride or carbonitride analogs.

Each of these compositions having empirical crystalline formulae Mₙ₊₁Xₙ or M′₂M″ₙXₙ₊₁ are described in terms of comprising at least one layer having first and second surfaces, each layer comprising a substantially two-dimensional array of crystal cells. In some embodiments, these compositions comprise layers of individual two-dimensional cells. In other embodiments, the compositions comprise a plurality of stacked layers.

In their free state, at least one of said surfaces of each layer of the MXene structures has surface terminations (optionally designated “Tₛ” or “Tₓ”) comprising alkoxide, carboxylate, halide, hydroxide, hydride, oxide, sub-oxide, nitride, sub-nitride, sulfide, thiol, or a combination thereof. In some embodiments, at least one of said surfaces of each layer has surface terminations comprising alkoxide, fluoride, hydroxide, oxide, sub-oxide, or a combination thereof. In still other embodiments, both surfaces of each layer have said surface terminations comprising alkoxide, fluoride, hydroxide, oxide, sub-oxide, or a combination thereof. As used herein the terms “sub-oxide,” “sub-nitride,” or “sub-sulfide” is intended to connote a composition containing an amount reflecting a sub-stoichiometric or a mixed oxidation state of the M metal at the surface of oxide, nitride, or sulfide, respectively. For example, various forms of titania are known to exist as TiOₓ, where x can be less than 2. Accordingly, the surfaces of the present invention can also contain oxides, nitrides, or sulfides in similar sub-stoichiometric or mixed oxidation state amounts.

### Exemplary Disclosure

The following disclosure is exemplary only and does not limit the scope of the present application or the appended claims.

Li-metal-anode is a useful choice for use in Li-batteries due to its high theoretical capacity (3680 mAh/g) and low redox potential (−3.04 V). As mentioned elsewhere herein, however, such Li-metal-anodes face certain practical issues, such as dendrite growth during Li plating/stripping process. This can result in short-circuit of the cell along with safety issues.

To address these issues, electrodeposition of Li into conducting framework is an effective approach. Transition metal carbides and transition metal nitride nanocrystals are very promising materials as the framework for Li deposition due to their comparatively high electron conductivity and lithiophilicity.

In meeting the long-felt needs in the art, the present disclosure provides, inter alia, two-dimensional (2D) arrays of transition metal nitrides and carbides nanocrystals as the conducting framework for Li deposition, realizing highly stable Li-metal-anode. The 2D arrays of metal nitrides and carbides include 2D arrays of CrN, TiN, NbN, Cr₂C, and the like. These methods provide a path to fabricating stable Li-metal-anodes for practical high energy Li-batteries.

### Synthesis of 2D Arrays of Chromium Nitride Nanocrystals

Example 2D arrays of chromium nitride nanocrystals were synthesized by three steps. Firstly, chromium chloride coated sodium chloride (NaCl@CrCl₂) powders were prepared. Typically, 17 mg CrCl₂ powder was dissolved in 10 ml ethanol with stirring for 30 minutes on a magnetic stirrer or sonication for 5 min, forming precursor solution. The precursor solution was further mixed with 100 g NaCl powder, drying at 50° C. with stirring to obtain NaCl@CrCl₂. Secondly, the NaCl@CrCl₂ was annealed at 700° C. for 2 hours at the ramp rate of 10° C./min under the NH₃ atmosphere. Finally, the product was washed by deionized water to remove NaCl and dispersed in deionized water. To obtain the powder of 2D arrays of chromium nitride, one can vacuum-filtrate the dispersion to membrane and dry in vacuum oven at 70° C.

### Synthesis of 2D Arrays of Titanium Nitride Nanocrystals

Example 2D arrays of titanium nitride nanocrystals were synthesized by three steps. Firstly, titanium ethoxide coated potassium chloride (KCl@TiEX) powders were prepared. Typically, 20 μl titanium ethoxide was dissolved in 10 ml ethanol with stirring for 30 minutes on a magnetic stirrer or sonication for 5 min, forming precursor solution. The precursor solution was further mixed with 100 g KCl powder, drying at 50° C. with stirring to obtain KCl@TiEX. Secondly, the KCl@TiEX was annealed at 750° C. for 2 hours at the ramp rate of 10° C./min under the NH₃ atmosphere. Finally, the product was washed by deionized water to remove KCl and dispersed in deionized water. To obtain the powder of 2D arrays of titanium nitride, one can vacuum-filtrate the dispersion to membrane and dry in vacuum oven at 70° C.

### Synthesis of 2D Arrays of Niobium Nitride Nanocrystals

Example 2D arrays of niobium nitride nanocrystals were synthesized by three steps. Firstly, niobium ethoxide coated potassium chloride (KCl@NbEX) powders were prepared. Typically, 14 μl niobium ethoxide was dissolved in 10 ml ethanol with stirring for 30 minutes on a magnetic stirrer or sonication for 5 min, forming precursor solution. The precursor solution was further mixed with 100 g KCl powder, drying at 50° C. with stirring to obtain KCl@NbEX. Secondly, the KCl@NbEX was annealed at 750° C. for 2 hours at the ramp rate of 10° C./min under the NH₃ atmosphere. Finally, the product was washed by deionized water to remove KCl and dispersed in deionized water. To obtain the powder of 2D arrays of niobium nitride, one can vacuum-filtrate the dispersion to membrane and dry in vacuum oven at 70° C.

### Fabrication of Freestanding Film for Li-Metal-Anode

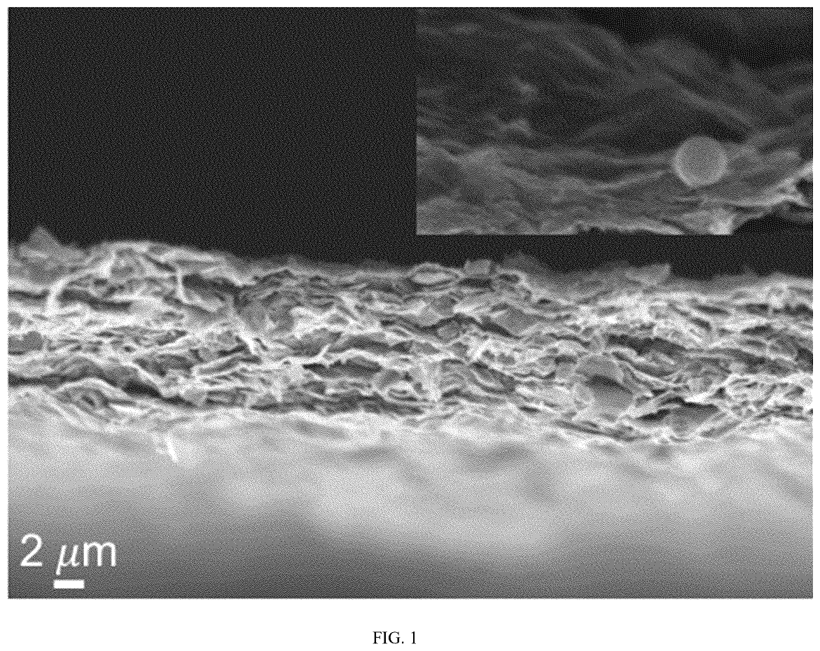

To fabricate freestanding film for Li-metal-anode. 2D arrays of transition metal nitrides and carbide nanocrystals were mixed with Ti₃C₂ MXene as the conductive binder. The Ti₃C₂Tₓ was prepared by HCl—LiF method as reported elsewhere. Ti₃C₂ MXene was dropped into the solution of 2D arrays of transition metal nitrides and carbides nanocrystals, followed by sonication for 1 minute or shaking for 5 minutes. Then the mixed solution was filtered through Celgard membrane via vacuum-assisted filtration. A freestanding film could be peeled off from membrane when it was almost dry. The electrode was further dried under vacuum at 70° C. for 24 h. The weight ratio of 2D arrays of metal nitrides and carbides nanocrystals and Ti₃C₂ MXene was tuned as 30:70, 50:50, 70:30, and 90:10, respectively. According to the cross-sectional scanning electron microscopy (SEM) image (FIG. 1), the freestanding film consisted of layered nanosheets, and the thickness of films is around 8 micrometers.

### Electrochemical Performance of Li-Metal-Anode

To test the long-term stability during Li plating/stripping process, coin-type (CR2032) cells were assembled in a glove box in which oxygen and water contents were controlled to be less than 1 ppm. Freestanding films were used as the cathode, lithium foil as the counter and reference electrode, which were electronically separated by a polypropylene (Celgard) membrane saturated with an electrolyte. The electrolyte solution was 1.5 mol L⁻¹ lithium bis(trifluoromethane sulfonel)imide (LiTFSI) and 1 wt. % LiNO₃ in a solvent mixture of 1, 3-dioxolane (DOL) and 1, 2-dimethoxyethane (DME) (volume ratio 1:1) as the electrolyte. For each electrode, around 30 μL electrolyte was added in the coin.

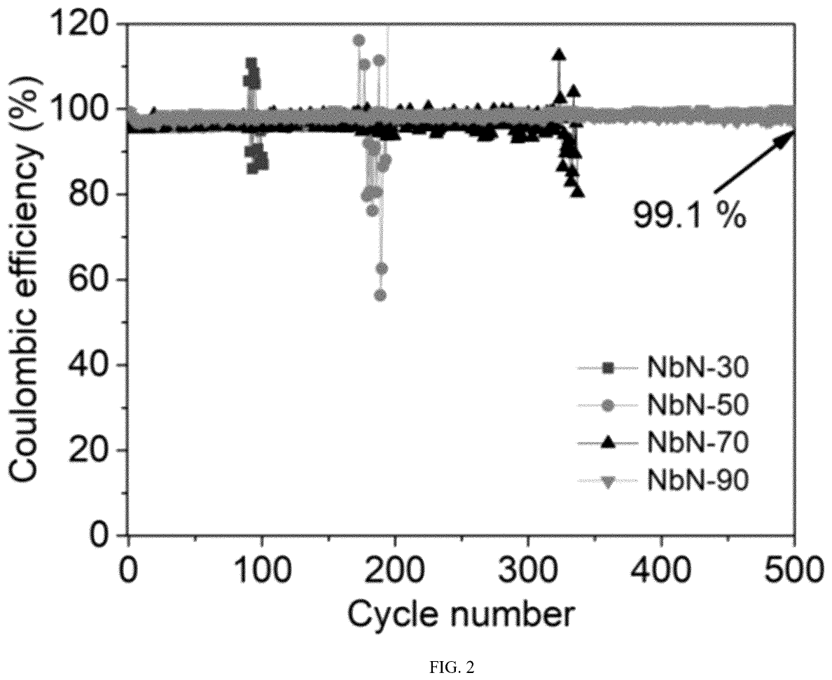

Using 2D arrays of NbN nanocrystals as an example, we tested the cycling stability of NbN/Ti₃C₂ freestanding films with different ratios (NbN-number means the weight percentage of NbN in film). As shown in FIG. 2, NbN-90 showed the most stable cycling performance, and the Coulombic Efficiency was more than 99% after 500 cycles, which is the one of the best performances in the reported literatures.

### SUMMARY

In conclusion, we have demonstrated 2D arrays of transition metal nitrides and carbides nanocrystals are the superior conducting framework for Li deposition, largely suppressing the uncontrollable Li dendrite growth as Li-metal-anode during cycling. This method can largely promote the development of practical Li-battery. These 2D arrays of transition metal nitrides and carbides nanocrystals have further applications, in various energy storage systems and beyond.

### Exemplary Disclosure—Nanocrystals

Herein is reported unique interconnected 2D arrays of few-nanometer TMN nanocrystals which are obtained through a topochemical synthesis on the surface of a salt template. As a simple demonstration of their application in a lithium-sulfur battery, it is shown that such a unique nanostructure can produce and has produced a highly stable and reversible capacity for 1000 cycles under a high areal sulfur loading (>5 mg cm⁻²), which is attributed to both the strong interaction with sulfur species and the fast electron/ion transport in these nanostructures.

The present invention is directed to two-dimensional transition metal carbides and nitrides, and compositions further comprising lithium sulfides, and methods of making the same. In certain of the embodiments, the methods comprise reacting a transition metal precursor salt (i.e., not a metal oxide), dispersed within a salt matrix, with a hydrocarbon or an amine in a non-oxidative or inert environment, for a time and under conditions sufficient so as to form the corresponding two-dimensional transition metal carbide or nitride, wherein the transition metal precursor comprises a metal of Group 3 to 14 of the Periodic Table, preferably a metal of Group 3 to 12 or Group 3 to 6.

Again, as described elsewhere herein, the present invention is directed to methods for preparing two-dimensional transition metal carbide or metal nitride compositions. In certain embodiments, the methods comprise reacting a transition metal precursor, dispersed within a salt matrix (e.g.), the transition metal precursor coating the salt crystals, with a hydrocarbon or amine, respectively, in a non-oxidative or inert environment, for a time and under conditions sufficient so as to form the corresponding two-dimensional metal carbide or metal nitride composition, wherein the metal precursor optionally is and comprises a metal of Group 3 to 14 of the Periodic Table. In further embodiments, the metal precursor comprises at least transition metal of any one of Groups 3 to 6 of the Periodic Table. In still other embodiments, the metal precursor comprises Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, or a combination thereof, preferably Ti, Zr, Hf, V, Nb, Ta, Cr, Mo, W, Mn, Re, Fe, Ru, Os, Co, Rh, Ir, Ni, Cu, Zn, or a combination thereof, more preferably Zr, Hf, V, Nb, Ta, Mo, W, Mn, or a combination thereof, still more preferably Ti, V, Nb, Ta, Mo, W, or a combination thereof, and most preferably Cr, Ti, Nb, or a combination thereof. In some embodiments, the metal (M′) nitrides are of the formula M′N, M′₂N, or M′₃N₂. It is to be appreciated that each individual metal precursor, or combination of any two or more precursors represents an independent embodiment.

In some embodiments, the metal precursor is loaded onto the salt matrix and dried to remove the solution solvent and the dried precursor coated salt is heat treated under inert atmosphere but in the presence of a hydrocarbon or an amine source. Exemplary temperatures for this treatment include heating at temperatures in a range of from about 400° C. to about 450° C., from about 450° C. to about 500° C., from about 500° C. to about 550° C., from about 550° C. to about 600° C., or a combination of two or more of these ranges.

As specified elsewhere herein, the transition metal precursors are non-crystalline, and can be salts or organometallic compounds. In some embodiments, the transition metal precursor is a halide (e.g., chloride, bromide, or iodide), a nitrate, or sulfate, or a C₁₋₆ alkoxide or aryloxide, e.g., methoxide, ethoxide, propoxide, butoxide, or pentoxide, or phenoxide.

In some embodiments, the crystalline two-dimensional metal carbides are formed by reacting the transition metal precursor/salt matrix with a hydrocarbon under otherwise reducing, non-oxidative, or inert conditions. Exemplary hydrocarbons include alkanes, for example methane, ethane, ethylene, propane, propylene, or a combination thereof, more preferably methane.

In some embodiments, the two-dimensional metal nitride compositions are formed by reacting the transition metal precursor/salt matrix with an amine under the non-oxidative, inert, or reducing conditions. Exemplary amines include ammonia, methyl amine, ethyl amine, propyl amine, cyanoamine, cyanamide, cyanourea, melamine, or a combination thereof. Ammonia is preferred for this purpose. As exemplified herein, the crystalline two-dimensional metal nitride composition comprises a nitride of Ti, Cr, Nb, Ta, Mo, W, or a combination thereof are particularly attractive, especially a nitride of Ti, Cr, and Nb.

The methods are thus far described in term of a non-oxidative, inert, or reducing environment. As described herein, the terms “inert environment” is substantially free of oxidizable species, such as air or oxygen, where substantially free refers to the absence of oxidizable species sufficient to compromise the desired reaction or the integrity of the corresponding crystalline two-dimensional transition metal carbide or metal nitride composition. While not necessary for the present methods, “reducing conditions” can include the additional presence of hydrogen in these reactions. However, more typically, the otherwise inert environment comprises the use of nitrogen, argon, or other gas inert to (non-reactive under) the reaction conditions.

In some aspects, the salt appears to provide a templating effect, to maintain the correct morphology during the reaction of the templated transition metal precursor with the amine or hydrocarbons. These salts, therefor are preferably inert to both oxidizing and reducing conditions. In preferred embodiments, the salts are preferably water-soluble alkali metal halides or sulfates or alkaline earth metal halides of sulfates, for example, MgCl₂, CaCl₂), SrCl₂, BaCl₂, NaCl, NaBr, NaI, KCl, KBr, KI, RbCl, RbBr, RbI, CsCl, CsBr, CsI, MgSO₄, CaSO₄, SrSO₄, BaSO₄, Na₂ (SO₄), K₂ (SO₄), Rb₂ (SO₄), Cs₂ (SO₄), or a combination thereof. In more preferred embodiments, the salts comprise NaCl, KCl, CsCl₂, Na₂SO₄, K₂SO₄, MgSO₄, or a combination thereof.

In certain embodiments, the weight ratio of the transition metal precursor to the crystalline salt is in a range of from about 1:1 to about 1:10, from about 1:10 to about 1:100, from about 1:100 to about 1:500, from about 1:500 to about 1:1000, from about 1:1000 to about 1:2500, from about 1:2500 to about 1:5000, or a combination of two or more of these ranges. As described in the Examples, compositions in which the weight ratio of the metal precursor to the salt in a range of from about 1:750 to about 1:1250, or about 1:1000 appears to work very well.

Also as described herein, in certain embodiments, the conditions sufficient to form the corresponding crystalline two-dimensional transition metal carbide or metal nitride composition comprise heating the transition metal precursor, dispersed within a salt matrix, with the hydrocarbon or amine at a temperature in a range of from about 500° C. to about 550° C., from about 550° C. to about 600° C., from about 600° C. to about 650° C., from about 650° C. to about 700° C., from about 700° C. to about 750° C., from about 750° C. to about 800° C., from about 800° C. to about 850° C., from about 850° C. to about 900° C., or a combination of two or more of these ranges. As exemplified herein, where the transition metal precursors are dispersed within the salt matrices by slurrying the two materials together, for example in an alcohol or aqueous solution, as exemplified in the examples, the use of an intermediate temperature, for example in a range of from about 100° C., 150° C., or about 200° C. to about 350° C. or about 400° C., can be useful to dry the solids before the higher temperature reaction conditions. In certain embodiments, these higher temperatures (e.g. from about 500° C. to about 900° C.) can be held for times ranging from about 1 hour to about 2 hours, from about 2 hours to about 4 hours, from about 4 hours to about 8 hours, from about 8 hours to about 12 hours, or a combination of two or more of these ranges. The times and temperatures can affect the stoichiometry of the crystalline carbide or nitride compositions, as discussed in the Examples.

Once formed, the crystalline two-dimensional metal carbide or metal nitride compositions can be separated from the salt matrix, preferably by dissolving the salt of the salt matrix. This is most conveniently done by adding the cooled reaction mixture to a volume of excess water, typically resulting in the formation of suspension of dispersed crystalline two-dimensional metal carbide or metal nitride flakes. These flakes can be isolated by vacuum filtration (to form arrays of overlapping flakes) or centrifugation. The isolated flakes can be re-suspended into aqueous solutions, for example, aqueous electrolytes, for further manipulation.

While the present invention has been described in terms of methods for producing these 2D transition metal carbides or metal nitrides, as flakes or powders, the present invention also contemplates those structures comprising layered arrays of two-dimensional transition metal carbide or metal nitride flakes. While these flakes have been described as those prepared by the methods described herein, it should also be appreciated that these methods are conducive to preparing structures previously unavailable by other methods. Certain embodiments, then, provide those flakes or arrays of 2D transition metal carbides or transition metal nitrides which are not limited by the methods of making.

Still other embodiments also provide for electronic device or energy storage devices comprising a layered array of two-dimensional metal carbide or metal nitride flakes as described herein. Such devices can include, for example, energy storage devices, electrocatalysis devices, electromagnetic interference shielding coating and devices, and other applications that require high electronic conductivity, for example plasmonic devices. Such compositions and devices include the mixing with, preferably by intercalation by alkali metal salts, preferably sulfides. In preferred embodiments, the alkali metal sulfides comprise lithium ions, sodium ions, and/or potassium ions. In more preferred embodiments, the alkali metal sulfides are lithium sulfides, for example Li₂S or Li₂S₆.

### EXAMPLES

The following Examples are provided to illustrate some of the concepts described within this disclosure. While each Example is considered to provide specific individual embodiments of composition, methods of preparation and use, none of the Examples should be considered to limit the more general embodiments described herein.

In the following examples, efforts have been made to ensure accuracy with respect to numbers used (e.g. amounts, temperature, etc.) but some experimental error and deviation should be accounted for. Unless indicated otherwise, temperature is in degrees C., pressure is at or near atmospheric.

### Example 1: General Overview

Due to the recent demonstration of promising properties of transition metal nitride (TMN) nanomaterials in fields ranging from plasmonics to energy harvesting, conversion and storage, the research of TMN nanomaterials especially the development of new synthesis techniques and material applications, has attracted great attention. As a typical example, there are two major challenges remaining in the cathodes of lithium-sulfur (Li—S) batteries—full utilization of sulfur and strong affinity between host materials and sulfur species. Interestingly, TMNs have been validated to have a strong interaction with sulfur species, in contrast to widely studied carbon materials. Combined with high electrical conductivity, TMN nanomaterials can help alleviate challenges. However, it should be noted that the promising performance was mainly achieved on low areal sulfur loading (below 3 mg cm⁻²) previously, while reaching the high and stable capacity during long-term cycling (>500 cycles) are still challenging but highly demanded for high areal sulfur loading cathode. This is due to the fact that the structure and conductivity cannot be optimized simultaneously in conventional synthesis methods, which is also a common issue in many research fields.

In general, zero-dimensional (0D) nanoparticles with very high surface area can provide highly exposed active sites. However, electron transport severely decreases if there are only physical contacts between self-assembled nanocrystals. On the other hand, two-dimensional (2D) metallically conducting flakes can conduct electrons to the less conducting material at their surface. A restacked MXene film shows an excellent conductivity, up to 8000 S cm⁻¹. Nevertheless, such a dense film (3-4 g cm⁻³) is not favorable for ultrahigh rate ion transport. Designing a nanostructure that takes advantages of both 0D and 2D morphologies can enable conductivity and accessibility simultaneously. One can hypothesize that interconnected few-nanometer TMN nanocrystals with overall 2D morphology would be a promising candidate, providing both high surface area and good electron/ion transport.

In this work, we report on synthesis of exemplary 2D arrays of few-nanometer TMN nanocrystals. Using topochemical synthesis, a thin layer of precursor on the surface of salt template was gradually transformed into TMN under a constant flow of ammonia. During ammoniation, the precursor was “etched” and recrystallized to form interconnected nanocrystals with few-nanometer size, arranged in unique 2D arrays. Precursor-coated salts were first prepared by coating a precursor solution in ethanol onto the surface of the salt and drying at 70° C. in air.

Here, precursors that can be directly ammoniated were chosen, which include chromium chloride, titanium ethoxide and niobium ethoxide, to later yield chromium nitride, titanium nitride and niobium nitride, respectively. Each precursor @salt was heated separately under a constant flow of ammonia for 2 h and transformed into a TMN salt with a blackish color.

With further washing of the salts in deionized water (DI water), 2D arrays of TMN nanocrystals could be separated and dispersed in solvents. Interestingly, although the color of concentrated solutions of various TMN nanocrystals are all black, their diluted colloidal solutions show different colors due to different electronic and optical properties of the produced nitrides. The colors were grayish, yellow-greenish and blackish for CrN, TiN and NbN, respectively.

The morphologies of the TMN nanocrystals were investigated by transmission electron microscopy (TEM). The overall morphologies were ultrathin flakes with lateral sizes varying from hundreds of nanometers to a few microns. Through atomic force microscopy (AFM) measurements, the thicknesses are estimated to be between 4 to 8 nm. According to enlarged TEM images, these TMN flakes are actually “pseudo” 2D flakes consisting of many interconnected few-nanometer nanocrystals. Statistically, the average domain size of each CrN nanocrystal is 4.7 nm, which is the smallest among the three TMNs samples, compared to 6.9 nm of TiN and 7.8 nm of NbN, respectively. This unique structure of 2D arrays of few-nanometer nanocrystals can provide more exposed active sites and allow ionic transport through the flakes due to the presence of pores between the nanocrystals. The specific surface area (SSA) was estimated to be 153, 57, 88 m² g⁻¹ for CrN, TiN and NbN, respectively.

The microscopic crystal structure was first characterized by high-resolution TEM (HRTEM). All the few-nanometer nanocrystals are single-crystalline. Two identical d-spacings of 2.0 Å with an angle of 90° were seen, which is in accordance with the theoretical d-spacing values of (200) and (002) facets of CrN (PDF #03-065-2899) with a square symmetry on the zone axis. The same square symmetries on the zone axis were visualized for both TiN and NbN, with slightly larger d-spacing values of (200) and (002) facets, which is possibly due to the larger atom sizes of Ti and Nb when compared to Cr. The crystal structures of three TMN nanocrystals were also demonstrated by X-ray diffraction (XRD). Three predominant peaks can be indexed to the cubic single-metal nitrides which is consistent with HRTEM analysis. In addition, the chemical composition of 2D arrays of TMN nanocrystals were probed by X-ray photoelectron spectroscopy (XPS). The predominant peaks in N Is region (396.8 CV for CrN, 396.2 eV for TiN, and 396.8 eV for NbN) were assigned to metal-N bonding, confirming the formation of metal nitrides. Another small peak next to metal-N bonding was assigned to metal-N—O bonding, which can be further confirmed in the metal region. The existence of O should be attributed to the oxygen termination of TMN surface.

To obtain a more quantitative atomic structure of the materials, X-ray pair distribution function (PDF) analysis was performed on these 2D arrays of TMN nanocrystals. The PDF describes the probability of finding two atoms in a material at a distance r apart and can be used to model the local structure of nanocrystals. After comparing the measured PDF results with PDF profiles computed from best-fit structural models, all three samples are shown to agree well with cubic TMN structures. Peaks in the PDF show interatomic bonding in the material. For instance, the first peaks around 2 Å in the three profiles further confirmed the presence of metal-N bonds. The cubic lattice parameters obtained after the structure refinement were 4.148 Å for CrN, 4.195 Å for TiN and 4.318 Å for NbN, respectively.

In addition, the X-ray PDF analysis can provide more specific information on crystallinity. Significantly, although the XRD patterns of all the three samples are very similar, their local structure PDF profiles are different. The PDF peaks of CrN and NbN are very sharp, while those of TiN are broad. Furthermore, the PDF signal extended to ˜8 nm for CrN, 6 nm for NbN, but only to 3.5 nm for TiN. Both the broader peaks and narrower r-range where signal is seen indicate that CrN and NbN have a higher crystallinity and a much lower level of positional disorder than TiN. Without being bound to any particular theory, we believe this phenomenon can be attributed to higher reactive surface of low-dimensional TiN, and that a larger amount of oxygen-termination exists on the surface of 2D arrays of TiN than CrN and NbN, and perhaps oxygen may dissolve in the lattice to form oxynitrides, resulting in lower structure ordering.

The growth mechanism of the 2D arrays of TMN nanocrystals was studied by comparing the morphology, crystal structure and chemical composition of samples ammoniated at different temperatures, but the same dwell time. Using CrN as an example, when ammoniating a precursor at 400° C., light green powders were obtained. A 2D nanosheet morphology, instead of 2D arrays of nanocrystals was achieved, as confirmed by TEM. However, no obvious peaks were found in the XRD pattern, while Cr—O bonding was verified in XPS, implying the formation of amorphous CrOx at this stage. Interestingly, two weak Cr—N and Cr—N—O bonding appeared in the N Is region of XPS, demonstrating the beginning of ammoniation and partial oxygen substitution by nitrogen. When increasing the temperature to 500° C., 2D arrays started to appear.

According to XRD pattern, all the peaks can be indexed to Cr₂O₃ (PDF #38-1479). Even though there is no phase of chromium nitride, the intensity of Cr—N bonding in XPS is enhanced, resulting from the further substitution of O by N. This trend is evident when the ammoniation temperature increased to 600° C. The XRD peaks were a little broader than in the pattern obtained at 500° C., validating that the domain size of the nanocrystal has decreased, which is in agreement with TEM results. Although they are still 2D arrays of Cr₂O₃, the Cr—N bonding becomes predominant in the XPS spectrum. Notably, the color of the sample treated at 600° C. changed from the typical greenish color of Cr₂O₃ to greyish. Finally, blackish powder was obtained after ammoniation at 700° C. At this stage, Cr₂O₃ was completely transformed to CrN, as confirmed by XRD. Combined with a very strong Cr—N bonding, the formation of 2D arrays of few-nanometer CrN nanocrystals has been verified.

To summarize, the growth process of 2D arrays of TMN nanocrystals is a topochemical synthesis process. During the heating, ultrathin transition metal oxide (TMO) flakes were first generated. Meanwhile, O was topochemically substituted by N via ammoniation. Given the intense reaction occurred in pure anhydrous ammonia and the huge differences in crystal structures and volumes between TMOs and TMNs, TMOs flakes were “etched” and recrystallized to few-nanometer TMN nanocrystals while retaining the overall 2D morphology. Control experiments validated our assumption. When annealing the precursor in air and Ar at 700° C., only layered nanosheets were obtained, demonstrating that the formation of 2D arrays of TMN nanocrystals occurred during ammoniation. These 2D arrays of few-nanometer TMN nanocrystals should be superior to self-assembled nanoparticles, in terms of the conductivity due to interconnected nanocrystals.

This can be favorable for applications requiring abundant active sites and high conductivity, such as electrochemical energy storage systems. As mentioned, TMNs have shown promising performance in Li—S batteries, but long-term stability and high areal sulfur loading still need to be addressed. An ideal sulfur cathode host for Li—S batteries should have the following characteristics: (i) strong surface affinity and high polar binding capability for polysulfides to suppress polysulfide shuttle effect; (ii) high specific surface area to ensure uniform dispersion of active sulfur and provide high-density exposed active sites for the chemical adsorption with polysulfides even at a high sulfur loading (>5 mg cm⁻²); (iii) high conductivity to endow an effective ion and electron pathway for long-term charge/discharge stability of the electrode at high current density. In our case, few-nanometer TMN nanocrystals can provide high surface area with strong affinity of polysulfides, which is favorable for fast ion diffusion and stable Li—S cathode at high sulfur loading. Moreover, 2D-like arrays of interconnected structure can assure fast electron transport in between nanocrystals.

We first investigated their absorption ability of polysulfides (Li₂S₆) (see details in Methods). The strong surface affinity for polysulfides can be directly verified in optical images. For example, 2D arrays of NbN could completely de-color the polysulfide solution within 5 minutes (20 mg of TMN nanocrystals powder was soaked in 10 mL of 5 mM Li₂S₆ solution at 25° C.), indicating fast and strong polysulfide adsorption capability. This result is consistent with the DFT results of the previous report. Ultraviolet/visible absorption measurements were conducted to probe the concentration changes of Li₂S₆ solutions. It can be seen from the static test that the absorption peak of Li₂S₆ in the visible light range (400 nm) disappeared after adding NbN powder for 5 minutes. Such a strong chemical interaction between TMN nanocrystals and polysulfides should be beneficial to restrain the polysulfide shuttle effect during long-term cycling.

Accordingly, three TMN/S composites were fabricated by a melting diffusion method. The sulfur loading percentages in all three composites are higher than 70 wt. % (NbN/S: 73.15 wt. %, TiN/S: 71.55 wt. % and CrN/S: 71.24 wt. %) as determined by thermogravimetric analysis (TGA). The chemical compositions were confirmed by XRD, elemental mapping and XPS. Firstly, the electrochemical performance of three composites was studied by assembling coin cell type batteries with areal sulfur loading of 2.0 mg cm⁻² (labelled as TMN/S−2.0). Two representative cathodic peaks were found in the cyclic voltammetry (CV) curves with no obvious shift within the initial 5 cycles. These peaks are attributed to the formation of long-chain polysulfides (Li₂Sₓ, 4<x≤8) from S₈, and subsequently the formation of short-chain sulfides (Li₂S₂ and Li₂S), respectively. The anodic peaks demonstrated the reversible conversion. All the three electrodes showed high initial reversible capacities and NbN/S has the best cycling stability. 93% of the reversible capacity of 1140 mAh g⁻¹ was retained after 100 cycles at 0.2 C. And when cycling at 0.5 C for 300 cycles, only 7.7% of capacity was lost and the voltage plateau showed no change. This cycling performance (0.026% degradation per cycle at 0.5 C) is among the best and superior to various transition metal oxide (TMO), TMN, and carbon-based cathodes with similar sulfur loading reported in literature (Table 2).

In practice, a higher areal sulfur loading (>5 mg cm⁻²) is useful for Li—S batteries. In this context, we focused on the most stable NbN/S electrode and fabricated a higher areal sulfur loading electrode of 5.1 mg cm⁻² (labeled as NbN/S−5.1). The NbN/S−5.1 electrode showed good rate performance and high Coulombic efficiency at scan rates ranging from 0.2 C to 5 C, similar to the NbN/S−2.0 electrode. It should be noted that NbN/S−5.1 is working well even at a high rate of 5 C, as the discharge plateau is still obvious and stable. Reversible and stable capacities of 1050 mAh g⁻¹, 979 mAh g⁻¹, 905 mAh g⁻¹, 745 mAh g⁻¹ and 560 mAh g⁻¹ are obtained at 0.2 C, 0.5 C, 1 C, 2 C and 5 C, respectively, which are only a bit lower than the capacities of NbN−2.0 electrodes without abrupt capacity degradation, demonstrating the excellent stability of the NbN−5.1 electrodes at different rates. Impressively, the NbN/S−5.1 electrode delivered an initial capacity of 912.8 mAh g⁻¹ and retained a high capacity of 796.5 mAh g⁻¹ (87.3%) with the stable capacity retention over 1000 cycles at 1 C (a slow degradation rate of 0.013% per cycle). To date, for most of the reported works, the long-term cycling test is generally carried out at a lower sulfur-loading due to the limited carbon-polysulfides or metal-polysulfides interaction interfaces in OD, 1D and 2D sulfur hosts materials (such as CNT, graphene, TMOs and other TMNs). To the best of our knowledge, this high rate cycling performance of the NbN/S−5.1 electrode is the best among slurry-based cathodes and many self-supporting cathodes with similar sulfur loading. The detailed comparison is presented in Table 2.

The performance of the high sulfur loading electrodes emphasizes the synergistic effect of high surface area, high-density active sites, inherently strong polysulfides affinity and high conductivity of the 2D arrays of TMN nanocrystals. The high specific surface area that resulted from the 2D arrays can keep the uniform distribution of large amounts of sulfur species, while strong interactions between them assures the stable trapping and reversible conversion of large amounts of polysulfides during long-term cycling. After several cycles, we checked the surface chemistry of a NbN/S electrode when discharged to 1.7 V. As compared to the initial NbN/S electrode, the predominant S Is peak (162.1 eV) was Li₂S, which demonstrated the reversible electrochemical conversion process during the charge/discharge cycling. Combined with the fast ion and electron transport provided by the interconnected 2D arrays of TMN nanocrystals, high mass loading cathodes can work at high rates, showing high capacity during charge/discharge cycling. Interestingly, given the good conductivity of 2D arrays of TMN nanocrystals, we also fabricated a NbN/S electrode without carbon black conductive additive. Both capacity and stability are similar to the traditional electrode with carbon black, implying the total volumetric capacity can be further increased by eliminating traditional conductive additive.

In conclusion, we report a general approach to high-yield synthesis of interconnected 2D arrays of few-nanometer TMN nanocrystals. Based on systematic analysis, we propose that the growth mechanism is a topochemical process. Because of the reaction with ammonia and the differences in crystal structures and volumes of TMOs and TMNs, during the synthesis, the initially formed TMOs were etched and topochemically transformed to interconnected few-nanometer TMN nanocrystals while retaining a 2D-like morphology. Such a unique structure provides high surface area and high conductivity as demonstrated in Li—S batteries. Combined with inherently strong interactions with sulfur species, 2D arrays of NbN nanocrystals-based electrodes show an ultra-stable and high specific capacity during 1000 cycles under high areal sulfur loading.

### Example 2. Materials and Methods

Example 2.1. Synthesis of 2D arrays of few-nanometer TMN nanocrystals. All chemicals were purchased from Sigma-Aldrich (USA). The 2D arrays of chromium nitride nanocrystals were synthesized in three steps. Firstly, chromium chloride coated sodium chloride (CrCl₂@NaCl) powders were prepared. Typically, 17 mg CrCl₂ powder was dissolved in 10 ml ethanol with stirring for 30 min on a magnetic stirrer or sonication for 5 min, forming the precursor solution, which was further mixed with 100 g NaCl powder and dried at 50° C. with stirring to obtain CrCl₂@NaCl. Secondly, the CrCl₂@NaCl was annealed at 700° C. for 2 hours at the ramp rate of 2° C./min under the constant flow of anhydrous NH₃. Finally, the product was washed with deionized water to remove NaCl and dispersed in deionized water. To obtain the powder of 2D arrays of chromium nitride, we vacuum-filtrated the dispersion on a membrane (Celgard) and dried the material in a vacuum oven at 70° C.

To produce 2D arrays of titanium nitride nanocrystals, firstly, titanium ethoxide coated potassium chloride (TiEX@KCl) powders were prepared. Typically, 20 μl titanium ethoxide was dissolved in 10 ml ethanol with stirring for 30 minutes on a magnetic stirrer or with sonication for 5 min, forming the precursor solution. The precursor solution was further mixed with 100 g KCl powder, and dried at 50° C. with stirring to obtain TiEX@KCl. Secondly, the TiEX@KCl was annealed at 750° C. for 2 hours at the ramp rate of 2° C./min under the constant flow of anhydrous NH₃. Finally, the product was washed by deionized water to remove KCl and dispersed in deionized water. To obtain the powder of 2D arrays of titanium nitride, we vacuum-filtrated the dispersion on a membrane (Celgard) and dried in vacuum oven at 70° C. for 12 h.

To produce 2D arrays of niobium nitride nanocrystals, niobium ethoxide coated potassium chloride (NbEX@KCl) powders were prepared. Typically, 14 μl niobium ethoxide was dissolved in 10 ml ethanol with stirring for 30 minutes on a magnetic stirrer or sonication for 5 min, forming the precursor solution. The precursor solution was further mixed with 100 g KCl powder, dried at 50° C. with stirring to obtain NbEX@KCl. Secondly, the NbEX@KCl was annealed at 750° C. for 2 hours at the ramp rate of 10° C./min under the constant flow of anhydrous NH₃. Finally, the product was washed by deionized water to remove KCl and dispersed in deionized water. To obtain the powder of 2D arrays of niobium nitride, we vacuum-filtrated the dispersion on a membrane and dried in vacuum oven at 70° C.

Example 2.2. Preparation of 2D arrays of TMN nanocrystals/sulfur composites. By a melting diffusion method, a mixture of 2D arrays of TMN nanocrystals and elemental sulfur (Sigma-Aldrich, ≥99%) (mass ratio=2.5:7.5) was quickly placed into a preheated horizontal furnace (at 155° C.) under ambient atmosphere for 20 hours, and then cooled down to room temperature.

Example 2.3. Preparation of Li₂S₆ solution. Li₂S₆ solution was prepared by dissolving Li₂S and elemental sulfur (with a stoichiometric ratio of 1:5) in a mixture of 1, 3-dioxolane (DOL) and 1, 2-dimethoxyethane (DME) (1:1 v/v) solvents.

Example 2.4. Electrochemical Measurements. Electrodes for lithium-sulfur batteries were fabricated by mixing 80 wt. % TMN/S composites, 10 wt. % carbon black (Super P, Sigma-Aldrich, ≥99%) and 10 wt. % Polyvinylidene fluoride (PVDF 6020, Sigma-Aldrich, >99%) in N-methyl-2-pyrrolidone (NMP, C₅H₉NO, Sigma-Aldrich, 99.5%) to form a slurry. Then, the slurry was spread onto an aluminum current collector (20 μm thickness) by a doctor blade. The electrode was dried under vacuum at 70° C. for 24 h. The area of cathode was 0.75 cm². The average sulfur loading mass on the “low” TMN/S composite electrodes were 2.0 mg/cm²; and a higher sulfur loading of 5.1 mg/cm² was also tested for NbN/S composite electrodes. Coin-type (CR2025) cells were assembled in a glove box (Mbraun, Unilab, Germany) in which oxygen and water contents were controlled to be less than 1 ppm.

Sulfur-containing electrodes were used as the cathode, lithium foil as the counter and reference electrode, which were electronically separated by a polypropylene membrane (3501 Coated PP, Celgard LLC, Charlotte, NC) saturated with an electrolyte. The electrolyte solution was 1.5 mol L⁻¹ lithium bis(trifluoromethane sulfonel)imide (LiTFSI, Sigma-Aldrich, 99.95%,) and 1 wt. % LiNO₃ (Sigma-Aldrich, ≥99%) in a solvent mixture of 1, 3-dioxolane (DOL, Sigma-Aldrich, ≥99%) and 1, 2-dimethoxyethane (DME, Sigma-Aldrich, ≥99%) (volume ratio 1:1) as the electrolyte. For each electrode, around 30 μL and 60 μL electrolyte was added in the coin cell for low and high sulfur loadings electrodes, respectively. Cyclic voltammetry (CV) and electrochemical impedance spectroscopy (EIS) measurements were conducted by using a VMP3 potentiostat (Biologic, France). CV tests were performed at a scan rate of 0.1 mV s⁻¹ in the voltage range of 1.7 to 2.8 V. The galvanostatic charge/discharge tests were carried out in the potential range of 1.7 to 2.8 V using an Arbin system (Arbin BT-2143-11U, College Station, TX, USA). All experiments were conducted at room temperature.

Example 2.5. Characterization. Transmission electron microscopy (TEM) was performed using a JEM-2100 (JEOL, Japan) with an accelerating voltage of 200 kV. Surface area was analyzed by isothermal nitrogen gas adsorption at the liquid nitrogen temperature. Specific surface areas (SSA) were calculated by fitting the N₂ adsorption-desorption data using Brunauer-Emmett-Teller (BET) theory. Ultraviolet-visible (UV-vis) spectroscopy was performed from 300-800 nm using an Evolution 201 Spectrophotometer (ThermoFisher Scientific, USA) in a 10 mm path length quartz cuvette. After the addition of TMN to the Li₂S₆ solution, UV-vis spectra were collected after 5 and 10 minutes. Thermogravimetric analysis was performed on a Discovery SDT 650. The nitride powders were dried at 90° C. prior to the measurement to remove the solvents, and packed in a 90 μL alumina pan. Before heating, the analysis chamber was flushed with He gas at 100 ml/min for 1 h. The samples were heated to 500° C. at a constant heating rate of 10° C./min in He atmosphere (100 mL/min). Atomic force microscopy (AFM) was performed using Bruker Multimode 8 with a Si tip (Budget Sensors Tap300A1-G; f₀=300 kHz, k=40 N/m) in a standard tapping mode in air.

X-ray diffraction (XRD) was carried out using a Rigaku Smartlab (Tokyo, Japan) diffractometer with Cu—Kα radiation (40 kV and 44 mA) with a step scan 0.02°, a step time of 1 sand a 10×10 mm² window slit. X-ray photoelectron spectroscopy (XPS) spectra were measured by a spectrometer (Physical Electronics, VersaProbe 5000, Chanhassen, MN) employing a 100 μm monochromatic Al Kα x-ray beam to irradiate each sample's surface. Photoelectrons were collected by a takeoff angle of 180° between the sample surface of each sample and the path to the analyzer.

Charge neutralization was applied using a dual beam charge neutralizer irradiating low-energy electrons and ion beam to minimize the shift in the recorded BE. The x-ray total scattering experiments for pair distribution function (PDF) analysis were carried out at the beamline 28-ID-2 (XPD) at the National Synchrotron Light Source II (NSLS-II) at Brookhaven National Laboratory. The data were collected at room temperature using the rapid acquisition PDF method (RAPDF) (17). A large area 2D Perkin Elmer detector (2048×2048 pixels and 200×200 μm pixel size) was placed 201.12 mm behind the sample which was loaded in a 1 mm ID kapton capillary.

The incident wavelength of the x-ray was λ=0.1867 Å. Calibration of the experimental setup was done by measuring crystalline nickel as a standard material to calibrate the sample-to-detector distance and to determine the Q_{damp} and Q_{broad} parameters which are the parameters that correct the PDF envelope function for the instrument resolution (18,19). The refined values Q_{damp}=0.035 Å⁻¹ and Q_{broad}=0.017 Å⁻¹ were fixed in the subsequent structural refinements of the PDF data.

The atomic positions of the slab models were fixed during the refinement. Some parameters used in structure refinement have the following functionalities: Uᵢₛₒ (Å²) is the isotropic atomic displacement parameters (ADPs) of atoms; δ1 (Å) is correlated motion related linear/quadratic term coefficient; SPD is the sample particle diameter, or rather the coherent domain size of the sample, obtained from a shape damping function applied to the sample.

### Aspects

The following Aspects are illustrative only and do not serve to limit the scope of the present disclosure or of the appended claims.

Aspect 1. A free-standing film, comprising: a 2D array of nanocrystals of a transition metal nitride, carbide, or a mixture thereof, the free-standing film optionally further comprising a MXene as a conductive binder.

Suitable MXenes are described elsewhere in the present disclosure. A MXene can comprise substantially two-dimensional array of crystal cells, each crystal cell having an empirical formula of Mₙ₊₁Xₙ, or M′₂M″ₙXₙ₊₁, where M, M′, M″, and X are defined elsewhere herein. M can be, e.g., Ti or Ta. Additionally, or alternatively, X is C.

Certain of these compositions include those having one or more empirical formula wherein Mₙ₊₁Xₙ comprises Sc₂C, Ti₂C, V₂C, Cr₂C, Cr₂N, Zr₂C, Nb₂C, Hf₂C, Ti₃C₂, V₃C₂, Ta₃C₂, Ti₄C₃, V₄C₃, Ta₄C₃, SC₂N, Ti₂N, V₂N, Cr₂N, Cr₂N, Zr₂N, Nb₂N, Hf₂C, Ti₃N₂, V₃C₂, Ta₃C₂, Ti₄N₃, V₄C₃, Ta₄N₃ or a combination or mixture thereof. In particular embodiments, the Mₙ₊₁Xₙ structure comprises Ti₃C₂, Ti₂C, or Ta₄C₃. In some embodiments, M is Ti or Ta, and n is 1, 2, or 3, for example having an empirical formula Ti₃C₂ or Ti₂C. In some of these embodiments, at least one of said surfaces of each layer has surface terminations comprising hydroxide, oxide, sub-oxide, or a combination thereof. In certain preferred embodiments, the MXene composition is described by a formula Mₙ₊₁Xₙ Tₓ, where Mₙ₊₁Xₙ are Ti₂CTₓ, MO₂TiC₂Tₓ, Ti₃C₂Tₓ, or a combination thereof, and Tₓ is as described herein. Those embodiments wherein M is Ti, and n is 1 or 2, preferably 2, are especially preferred.

In still further embodiments, the empirical formula M′₂M″ₙXₙ₊₁ comprises Mo₂TiC₂, Mo₂VC₂, Mo₂TaC₂, Mo₂NbC₂, Mo₂Ti₂C₃, Cr₂TiC₂, Cr₂VC₂, Cr₂TaC₂, Cr₂NbC₂, Ti₂NbC₂, Ti₂TaC₂, V₂TaC₂, or V₂TiC₂, preferably Mo₂TiC₂, Mo₂VC₂, Mo₂TaC₂, or Mo₂NbC₂, or their nitride or carbonitride analogs. In still other embodiments, M′₂M″ₙXₙ₊₁ comprises Mo₂Ti₂C₃, Mo₂V₂C₃, MO₂Nb₂C₃, MO₂Ta₂C₃, Cr₂TizC₃, Cr₂V₂C₃, Cr₂Nb₂C₃, Cr₂Ta₂C₃, Nb₂Ta₂C₃, Ti₂Nb₂C₃, Ti₂Ta₂C₃, V₂Ta₂C₃, V₂Nb₂C₃, or V₂Ti₂C₃, preferably MO₂Ti₂C₃, MO₂V₂C₃, MO₂Nb₂C₃, MO₂Ta₂C₃, Ti₂Nb₂C₃, Ti₂Ta₂C₃, or V₂Ta₂C₃, or their nitride or carbonitride analogs.

Aspect 2. The free-standing film of Aspect 1, wherein the transition metal nitride comprises a metal of Groups 3 to 14, e.g., a metal of Groups 3 to 12. In still other embodiments, the metal precursor comprises Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, or a combination thereof, preferably Ti, Zr, Hf, V, Nb, Ta, Cr, Mo, W, Mn, Re, Fe, Ru, Os, Co, Rh, Ir, Ni, Cu, Zn, or a combination thereof, more preferably Zr, Hf, V, Nb, Ta, Mo, W, Mn, or a combination thereof, still more preferably Ti, V, Nb, Ta, Mo, W, or a combination thereof, and most preferably Cr, Ti, Nb, or a combination thereof. The foregoing preferences are preferences only, and do not exclude other metals.

Aspect 3. The free-standing film of Aspect 2, wherein the transition metal nitride comprises a metal of Groups 3-12.

Aspect 4. The free-standing film of Aspect 3, wherein the transition metal nitride comprises a metal of Groups 3-6.

Aspect 5. The free-standing film of Aspect 1, wherein the nanocrystals of a transition metal nitride, carbide, or a mixture thereof comprise Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, or a combination thereof.

Aspect 6. The free-standing film of Aspect 5, wherein the nanocrystals of a transition metal nitride, carbide, or a mixture thereof comprise Ti, Zr, Hf, V, Nb, Ta, Cr, Mo, W, Mn, Re, Fe, Ru, Os, Co, Rh, Ir, Ni, Cu, Zn.

Aspect 7. The free-standing film of Aspect 6, wherein the nanocrystals of a transition metal nitride, carbide, or a mixture thereof comprise Zr, Hf, V, Nb, Ta, Mo, W, Mn, or a combination thereof.

Aspect 8. The free-standing film of Aspect 7, wherein the nanocrystals of a transition metal nitride, carbide, or a mixture thereof comprise Ti, V, Nb, Ta, Mo, W, or a combination thereof.

Aspect 9. The free-standing film of Aspect 1, wherein the nanocrystals of a transition metal nitride, carbide, or a mixture thereof comprise Cr, Ti, Nb, or a combination thereof.

Aspect 10. A lithium-metal-anode, comprising the freestanding film of any one of Aspects 1-9.

Aspect 11. A lithium ion battery, comprising the freestanding film of any one of Aspects 1-9 or a lithium-ion-anode of Aspect 10.

Aspect 12. An electronic device, comprising: a free-standing film of any one of Aspects 1-9, a lithium metal anode of Aspect 10, a lithium ion battery of Aspect 11.

Aspect 13. The electronic device of Aspect 12, wherein the electronic device is an energy storage device, a device useful for electrocatalysis, electromagnetic interference shielding, or any combination thereof. Example such devices include, e.g., batteries (as energy storage devices), electromagnetic shields that can be superposed between a source of an electromagnetic field and an object (or a region of an object) that is to be shielded from the electromagnetic field.

One can operate the energy storage device that includes the disclosed films. One can also effect electrocatalysis using an appropriate film according to the present disclosure, e.g., by communicating a current through such a film. One can also use a film according to the present disclosure as an electromagnetic shield, e.g., by superposing the film over an object (or a region of an object) to be shielded from an electromagnetic field.

Aspect 14. A method, comprising communicating a current to a free-standing film according to any one of Aspects 1-9. This can be accomplished by, e.g., charging a battery that comprises the film.

Aspect 15. A method, comprising operating a lithium-metal anode according to Aspect 10. This can be accomplished by, e.g., effecting disposition of lithium onto (or off of) the film, applying a current to the anode, and the like.

Aspect 16. A method, comprising charging or discharging a lithium ion battery according to Aspect 11. Such a battery can be in electronic communication with an electrical load, e.g., a computing device, a motor, and the like.

Aspect 17. A method, comprising operating an electronic device according to Aspect 13. Such an electronic device can be, e.g., a computing device, a motor, and the like.

Aspect 18. A method, comprising depositing a metal or a metal ion onto or within a film according to any one of Aspects 1-9. Such deposition will be known to those of ordinary skill in the art.

Aspect 19. A method, comprising releasing a metal or a metal ion from a film according to any one of Aspects 1-9.

Aspect 20. A method, comprising fabricating a free-standing film according to any one of Aspects 1-9. Suitable methods are described elsewhere herein.

As an example, to fabricate a freestanding film for, e.g., a Li-metal-anode, 2D arrays of transition metal nitrides and/or carbide nanocrystals can be mixed with a MXene, e.g., Ti₃C₂, with the MXene being characterized as the conductive binder. The MXene can be contacted to a solution of the 2D arrays of transition metal nitrides and/or carbides nanocrystals, optionally followed by agitation (e.g., sonication, shaking, stirring, etc.).

The mixed solution can be filtered through a membrane (e.g., a Celgard membrane), which can be accomplished by via vacuum-assisted filtration or other techniques. A freestanding film can then be peeled off from the membrane. The film can the be dried, cut, or otherwise further processed. Without being bound to any particular configuration, a film can include layered nanosheets. A film thickness can be in the range of, e.g., about 5 to about 20 micrometers.

### REFERENCES

The following references are provided for convenience only. The reference listing is not concession that any reference is necessarily relevant in any way to the patentability of the disclosed technology.
1. Gogotsi, Y. G.; Andrievski, R. A. (Eds.), Materials Science of Carbides, Nitrides and Borides, NATO Science Series (Kluwer, Dordrecht, N L 1999).
2. Naik, G. V. et al. Titanium nitride as a plasmonic material for visible and near-infrared wavelengths.Opt. Mater. Express 2, 478-489 (2012).
3. Alhabeb, M. et al. Guidelines for Synthesis and Processing of Two-Dimensional Titanium Carbide (Ti₃C₂T₂ MXene). Chem. Mater. 29, 7633-7644 (2017).
4. Liang, X. et al. A facile Surface Chemistry Route to a Stabilized Lithium Metal Anode. Nat. Energy. 2 17119 (2017).

What is claimed:

1. A free-standing film, comprising:
a 2D array of nanocrystals of a transition metal nitride, carbide, or a mixture thereof, the free-standing film optionally further comprising a MXene as a conductive binder.
